(19) United States
(12) Patent Application Publication
(10) Pub. No.: US 2021/0073857 A1
(43) Pub. Date: Mar. 11, 2021

(54) ANONYMOUS CONTENT RECOMMENDATION ENGINE

(71) Applicant: Charter Communications Operating, LLC, St. Louis, MO (US)

(72) Inventor: Karim GHESSASSI, Parker, CO (US)

(21) Appl. No.: 16/562,691

(22) Filed: Sep. 6, 2019

(51) Int. Cl. G06Q 30/02; H04N 21/466; H04N 21/25

(52) U.S. Cl. CPC G06Q 30/0255; H04N 21/251; H04N 21/4668; G06Q 30/0272

(57) ABSTRACT

Systems, methods, and devices of the various embodiments include receiving content experience data, associated with a first consumer ID, which may identify the first consumer ID and include a first content ID and an experience period indicator. The first content ID may be associated with a first content consumed by the target consumer and the experience period indicator may be a measure of a consumption period when the first content was played by the first consumer ID. A first engagement level (EL) of the first consumer ID may be determined for the first content ID based on the consumption period. A recommendation cluster may be determined, for the first consumer ID, which may comprise other consumer IDs with a second EL for the first content ID that matches the first EL. A content recommendation may be determined from a content set comprising additional content IDs played by the recommendation cluster.

### BACKGROUND

A wide variety of video and/or audio recordings (i.e., content) are available to consumers from many sources. In fact, there are so many offerings and sources that consumers are often unaware of many content offerings available to them that they might enjoy viewing if the consumer were made aware of the content availability. Additionally, some consumers like to record content using a digital video recorder (DVR). However, current DVR systems require manual intervention from the consumer to select and/or schedule recordings. A challenge to the consumer is that, often, they may forget to record their favorite content. In addition, the consumer might think about recording specific content after they hear about it, but they might not be in the presence of their DVR interface and as a result the consumer forgets about the content at the later time when the consumer in the presence of their DVR. Further, with the overwhelming amount of available content, many consumers may feel the time spent programming a DVR is simply too time-consuming.

Content providers know that any frustration felt by a subscription consumer may result in that consumer following the growing trend in television viewership, which is to cancel their service contracts with content distributors (e.g., canceling cable television service from a cable television provider, sometimes colloquially referred to as “cutting the cord”), which has resulted in lost revenue for content distributors. Thus, content providers desire better ways of identifying content consumers might enjoy and making content recommendations based on this information.

Contemporary recommendation engines for either content or even physical products work by either recommending related items or using consumer demographics to recommend products/content that other consumers in the same demographic use. Recommending related items has high overhead costs since it requires continuously having to update databases that store items/content that are related to other items/content. This often requires a manual or automated curation process for items/content, in which categories for items/content or relationships between items/content must be regularly maintained. Recommending items using consumer demographics or almost any personal information may also be complicated by privacy issues.

### SUMMARY

Various embodiments describe methods, systems and devices for making content recommendations to a consumer. Various embodiments include receiving content experience data associated with a first consumer ID. The content experience data may identify the first consumer ID and include a first content ID and an experience period indicator. The first content ID may be associated with a first content consumed by the target consumer and the experience period indicator may be a measure of a consumption period when the first content was played by the first consumer ID. A first engagement level (EL) of the first consumer ID may be determined for the first content ID based on the consumption period. In addition, by accessing a recommendation cluster database, a recommendation cluster may be determined for the first consumer ID. The recommendation cluster may comprise other consumer IDs with a second EL for the first content ID that matches the first EL. At least one content recommendation may be determined from a content set comprising additional content IDs played by the recommendation cluster. The at least one content recommendation may be stored to a storage device associated with an account of the target consumer.

In some embodiments, the content experience data may also include feedback from the first consumer ID related to the first content ID. The consumption period may include at least one of an elapsed time, a time of day, a day of the week, or a date during which the content was played by the first consumer ID. The first EL may reflect how long the consumption period is relative to a complete run-time of the content. The first EL may be associated with a time of day the first content was played by the first consumer, wherein the recommendation cluster comprises other consumer IDs with the ELs associated with the time of day the first content was played by the first consumer. The first EL may be determined, at least in part, using a previous playing of the first content by the first consumer.

In some embodiments, an EL enhancement may be determined for adjusting the determined EL, wherein the EL enhancement uses a weighting factor applied to the first EL to adjust the first EL used in matching the second EL for determining the recommendation cluster. A separate EL of the first consumer ID may be determined for each of one or more additional content IDs based on corresponding consumption periods, wherein the recommendation cluster includes only other consumer IDs with a threshold number of matching EL's for the corresponding one or more additional content IDs. The recommendation cluster may exclude other consumer IDs that did not play the first content within a predetermined time-window relative to the consumption period. The predetermined time-window may be selected from a group comprising, a) a same day of the week as that of the consumption period; b) a period of time on the same date as the consumption period; c) a date; or d) a period of time on the same day of the week as that of the consumption period. The at least one content recommendation may be selected from a list of additional content IDs based on a popularity of the additional content IDs within the recommendation cluster.

In some embodiments, the at least one content recommendation may be determined by adding content not included in the content recommendation set. Determining the at least one content recommendation may include changing an order in which content is recommended. The content recommendation set determination may include additional content IDs played by the recommendation cluster, wherein the determined content recommendation set does not include additional content IDs played by the recommendation cluster less than a threshold number of times. The content associated with the at least one content recommendation may be automatically recording, by the processor to a media storage device, without input from a user of the first consumer ID specifically instructing that the content associated with the at least one content recommendation be recorded. The content experience data may be removed by the processor from the recommendation cluster database in response to the content experience data expiring.

Further aspects include a glove including a processor configured with processor-executable instructions to perform operations of any of the methods summarized above. Further aspects include a non-transitory processor-readable storage medium having stored thereon processor-executable software instructions configured to cause a processor of a glove to perform operations of any of the methods summarized above. Further aspects include a processing device for use in a glove and configured to perform operations of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a block diagram of an example computing device suitable for use with various embodiments.

FIG. 2 is a system block diagram of an IP network for distributing content and content recommendations suitable for use with various embodiments.

FIG. 3 is a process flow diagram illustrating an embodiment method for making content recommendations to a target consumer suitable for use with various embodiments.

FIG. 4 is a process flow diagram illustrating an embodiment method for making content recommendations with an EL enhancement suitable for use with various embodiments.

FIG. 5 is a process flow diagram illustrating an embodiment method for making content recommendations with additional content played by the target consumer suitable for use with various embodiments.

FIG. 6 is a process flow diagram illustrating an embodiment method for making content recommendations with a determined content set suitable for use with various embodiments.

FIG. 7 is a process flow diagram illustrating an embodiment method for making content recommendations that removes expired content experience data suitable for use with various embodiments.

FIG. 8 is a component diagram of another example computing device suitable for use with various embodiments

FIG. 9 is a component diagram of another example computing device suitable for use with various embodiments.

FIG. 10 is a component diagram of an example streaming media player or DVR suitable for use with the various embodiments.

FIG. 11 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The various embodiments may determine an anonymous recommendation metric that may be used to recommend content to consumers. The anonymous recommendation metric may be used to make recommendations and/or automatically record content likely of interest to a consumer. In addition, various embodiments may help consumers with DVR service, who don't have the time or forget to schedule the recording of their favorite content, to automatically record such content.

The various embodiments may enhance consumer privacy by determining and providing content recommendations without the need to collect personal data or other meta-data about the consumer. In addition, aspects of various embodiments do not rely on consumer historical or demographic data, which may be banned is some jurisdictions due to privacy concerns.

The various embodiments may provide a recommendation engine that does not require constant curation (i.e., human maintenance), such as by maintaining manually created category or related content data for massive content libraries.

The various embodiments are scalable and may be used in almost any part of the world since the recommendation engine, in accordance with various embodiments, is agnostic to the language used in the content, any political or other bias contained in the content, and/or any other factor related to the actual substance of the content. By using metrics based solely or at least primarily on an engagement level of content, which may be matched to other consumers exhibiting the same or similar engagement level, various embodiments may recommend other content without the need for further detailed information about the consumers.

As used herein, the term “content” may refer to multimedia, including but not limited to audio and/or video recordings broadcast or otherwise transmitted to consumers. Content may include multimedia content, a video from a video-sharing website/service or social network, podcasts, news, music, or a television program, show, series, etc., that is provided by a programmer (e.g., Turner Broadcasting®, ESPN®, Disney®, Viacom®, etc.) to a content distributor network (e.g., Charter®, Comcast®, DirecTV®, Sling® TV etc.) for Internet Protocol (IP) streaming (e.g., adaptive bit rate (ABR) streaming, such as Apple Hypertext Transfer Protocol (HTTP) Live Streaming (Apple HLS), Dynamic Adaptive HTTP (DASH), etc., or any other type IP streaming) on a channel provided by the content distributor network and associated with that programmer Programmers (e.g., Turner Broadcasting, ESPN, etc.) may encode and package content for delivery by the content distributor networks to consumers (also referred to as customers or viewers) via IP streaming services offered by the content distributor networks (e.g., Charter®, Comcast®, DirecTV®, Sling® TV etc.). The content provided by the programmers may be grouped by programmer on one or more channels associated with each respective programmer provided by the content distributor networks. For example, a first channel may be dedicated by a content distributor network to content provided by Turner Broadcasting and a second channel may be dedicated by the content distributor network to content provided by ESPN®. The programmers and content distributor networks may have contractual obligations with one another such that advertisements are included in the content as the content is consumed (i.e., viewed) are output to the consumers (i.e., viewed through the consumer's account) and compensation is exchanged between the programmers and content distributor networks based on the consumers consuming the content including the advertisements. Through the consumer's respective computing device, a consumer (also referred to as a customer or a viewer) may select content offered by the consumer's respective content distributor network (i.e., the content distributor network providing service to the consumer's computing device) to output (i.e., play, view, consumed) the content provided by the programmer.

As used herein, the term “computing device” is used to refer to any one or all of satellite or cable set top boxes, smart remote control devices (i.e., television remote controls with sufficient processing capabilities), laptop computers, rack mounted computers, routers, cellular telephones, smart phones, smart watches, personal or mobile multi-media players, personal data assistants (PDAs), personal computers, tablet computers, smart books, palm-top computers, desk-top computers, wireless electronic mail receivers, multimedia Internet enabled cellular telephones, wireless gaming controllers, streaming media players (such as, ROKU®), smart televisions, DVRs, modems, and similar electronic devices which include a programmable processor and memory and circuitry for providing the functionality described herein.

The various embodiments are described herein using the term “server” to refer to any computing device capable of functioning as a server, such as communications server, a name server, a master exchange server, web server, mail server, document server, database server, route server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as a server only to the extent necessary to provide the functionality described herein.

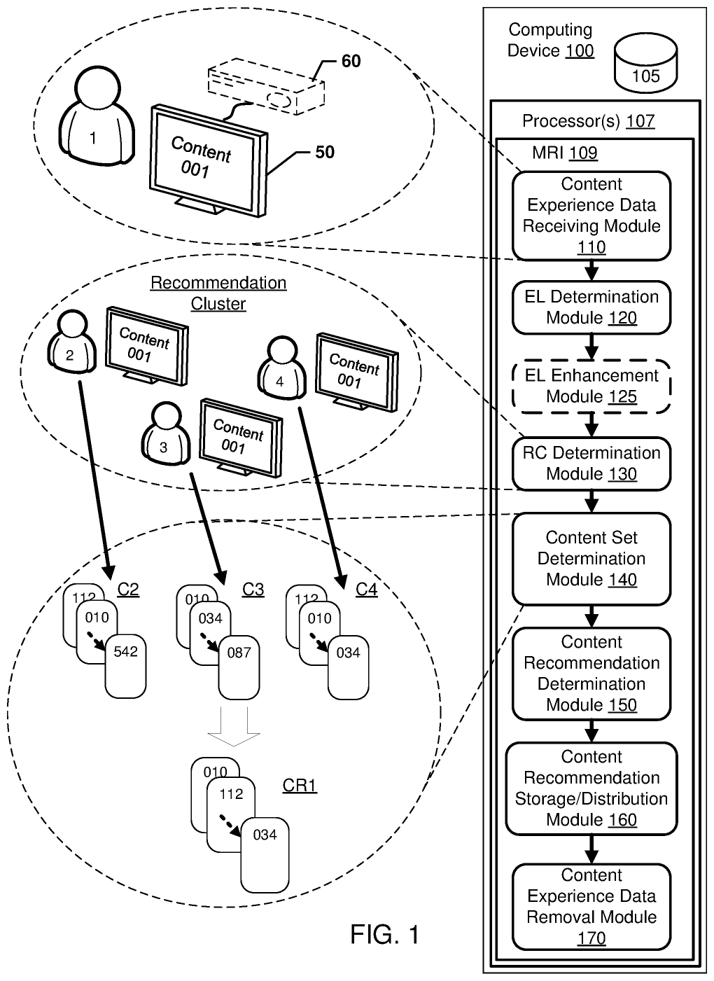

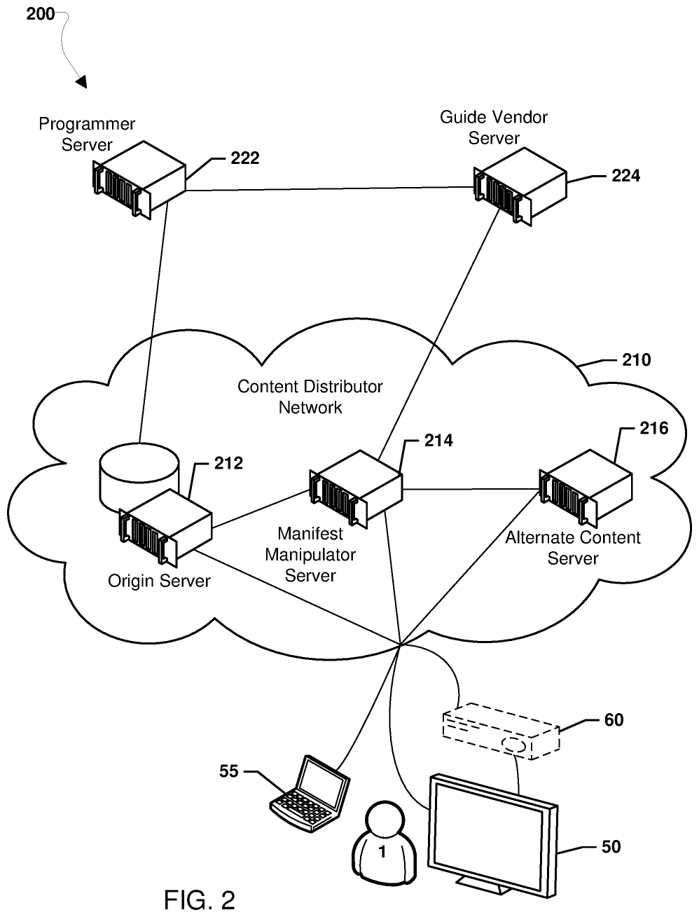

FIG. 1 illustrates a schematic diagram of a computing device 100 configured for making content recommendations to a target consumer. In various embodiments, the computing device 100 may represent one or more computing devices including consumer computing devices (e.g., a television, set-top box, personal computer, laptop, tablet, and the like), distributor network computing devices (e.g., origin server, manifest manipulator server, alternate content server, and the like illustrated as 50, 55, and 60 in FIG. 2), programmer computing devices, guide vendor computing devices, and/or other remote computing devices. The computing device 100 may include one or more memory storage devices 105 and one or more processors 107.

Computing device 100 may be configured by machine-readable instructions (MRI) 109. The MRI 109 may include one or more instruction modules. The instruction modules may include computer program modules. The instruction modules may include one or more of a content experience data receiving module 110, an engagement level (EL) determination module 120, an EL enhancement module 125, a recommendation cluster (RC) determination module 130, a content set determination module 140, a content recommendation determination module 150, a content recommendation storage/distribution module 160, a content experience data removal module 170, or other instruction modules.

The content experience data receiving module 110 may be configured to receive content experience data associated with a first consumer ID (e.g., ID number “1”) and a first content ID. The content experience data may identify the first consumer ID and may include a first content ID (e.g., “001”) and an experience period indicator. The first consumer ID may represent one consumer account or may represent a sub-account for one household. For example, one household may have one sub-account for each active household member. Alternatively, the first consumer ID may be associated with one or more particular computer devices associated with an account.

The first content ID may be associated with a first content outputted and consumed (i.e., played) by the target consumer. The experience period indicator may be a measure of a consumption period when the first content was played by the first consumer ID. In this way, the experience period indicator may be a measure of the cumulative playing time (i.e., continuous or non-continuous) by the first consumer ID. More than one playing of the first content may be reflected by a consumption period that is longer than the total run-time of the first content. Optionally, the consumption period may be conveyed as a percentage of the total run-time of the content. Alternatively, the experience period indicator may include a measure of the first uninterrupted playing of the first content by the first consumer ID in addition to or in place of the cumulative playing time. In various embodiments, the experience period indicator may additionally identify a time, day of the week, or date the first content or segments thereof were played.

In addition or alternatively, the content experience data associated with the first consumer ID may further include a computing device identifier. The computing device identifier may later be used to associated or link content recommendations to a particular computing device or group of computing devices of a consumer. This aspect may be helpful for households with more than one consumer, all using the same consumer ID account.

As a further addition or alternative, the content experience data may include feedback from the target consumer about the content associated with the content ID. In various embodiments, the target consumer feedback may be a ranking or other directly quantifiable metric. For example, the target consumer may have rated the content, such as on a numerical scale (e.g., 1-to-10), a number of stars or other symbol (e.g., 1-to-5 stars), a disapproval indicator (e.g., thumbs down), an approval indicator (e.g., thumbs up), or other form of directly quantifiable metric. In various embodiments, the target consumer feedback may be in the form of written or spoken feedback, such as comments provided by the target consumer that either describe the content or describes the consumer's experience with the content.

The content experience data may be received at any point during and after the time the target consumer plays the content. For example, immediately in response to the target consumer starting to play a particular content, the content experience data receiving module 110 may receive the content experience data. Alternatively, the content experience data receiving module 110 may not receive the content experience data until after a predetermined period (e.g., after 25%, 50%, or 100% of the content has been played).

The EL determination module 120 may be configured to determine an engagement level (EL) of the first consumer ID associated with the first content ID based on the consumption period. In various embodiments, the EL may directly reflect how long the consumption period is, relative to a complete run-time of the content. Thus, the EL may be expressed as a percentage of the complete run-time of the content. In this way, if a consumer watches only a quarter of the content the EL may be 25, if that consumer watches the entire content the EL may be 100, or if the consumer watches the content twice the EL may be 200.

Similarly, related content, such as different episodes of the same television show or series may use a single content ID. In this way, a total run-time of the whole series may be used for determining the EL, as opposed to the total run-time of just one episode.

Since a household may have more than one consumer, various embodiments may be associated or limit a determined EL for any particular content ID to the time of day the content was played or the device used to play the content. For example, children in a household may be limited to certain times of the day in which they are permitted to consume content. In addition, children in the household may be limited to consuming content on particular devices. Parents in the household may be working and thus content consumption is limited to evening hours. By associating or limiting the determined EL in this way may account for the different consumers. For example, one household member may like to watch kids shows in the morning, another household member may watch day-time television at midday, and yet another household member may watch the news at night. In this way, linking the determined EL to the time or part of the day the content was consumed may more accurately identify other consumers with similar tastes to the associated household member. Similarly, various embodiments may associate or limit a determined EL for any particular content ID to the device used to play the content. Associating or limiting the determined EL in this way may similarly account for the different consumers in a household. For example, one household member may like to watch content on the kitchen television, another household member may like to watch content on a tablet, smart phone, or other mobile device, and yet another household member may like to watch content in a home theatre. In this way, linking the determined EL to the device used to play the content may later more accurately identify other consumers with similar tastes to the associated household member.

When a consumer first starts to play content, the content experience data at that point may not be a good indicator of that consumer's engagement level with that content. Thus, in various embodiments, the EL determination module 120 may access a historical records database for the target consumer to factor-in a previous playing of that same or related content for determining the EL. For example, ten minutes into the start of the first content being played, the EL determination module 120, accessing the historical records database, may determine that the same consumer previously watched the same content. Thus, the EL determination module 120 may base the EL determination not only on the current playing of the first content but also a previous playing of the same or related content in determining the EL. Alternatively, the EL determination module 120 may use a limited week-day model that only looks at historical playing habits on the same day of the week. Thus, the EL determination module 120 may alternatively base the EL determination not only on the current viewing of the first content but also last week's viewing of the same or related content on the same day of the week in determining the EL.

Various embodiments may optionally include an EL enhancement module 125, which may be configured to determine an enhancement for adjusting the determined EL of the first consumer ID for the first content ID. In addition, the EL enhancement module 125 may be configured to adjust the determined EL based on the determined enhancement. The EL may be enhanced by the EL enhancement module 125 to take into account other factors for a particular consumer, content, or other circumstance.

The EL enhancement module 125 may modify the determined EL for any particular content ID by factoring-in feedback in the form of directly quantifiable metrics received from the target consumer, if included with or as a supplement to the content experience data. For directly quantifiable metrics, like rankings, the EL enhancement module 125 may enhance the originally determined EL by one or more weighting factors tied to the directly quantifiable metrics. For example, repeated play of content may have a weighting equal to the number of replays or partial replays, which may be used as a function of the determined EL for calculating an enhanced EL. In this way, playing the content once may have a weighting of one (1), playing the content twice may have a weighting of two (2), playing the content two and a half times may have a weighting of two and a half (2.5), and so on. Alternatively, each viewing may have a different weighting that may be applied to the initially determined EL. Similarly, related content, such as different episodes of the same television show or series may be associated with one another and used like a repeated play as a weighting factor for determining the EL. For example, watching three episodes of a series may be equated to watching the first episode three times.

In various embodiments, the determined EL for any particular content ID may be enhanced by factoring-in feedback in the form of written or spoken feedback received from the target consumer, if included with or as a supplement to the content experience data. In the case of written or spoken feedback, the EL determination module 120 may include a speech-to-text conversion function, for translating spoken word to text, and a word or language analysis function, for parsing words and identifying key words or phrases associated with positive or negative reviews. Alternatively, the computing device 100 may include a separate module or sub-module of the EL determination module 120 that includes speech-to-text conversion, language parsing, and or language analysis capabilities. Once the written or spoken feedback is translated and analyzed, the EL determination module 120 may enhance the originally determined EL by one or more weighting factors associated with analysis results.

The EL enhancement module 125 may modify the determined EL for any particular content ID by factoring-in a content-provider weighting for particular content. For example, a distributor or content provider wanting to push or otherwise encourage particular content may add a weighting to that content so it is more likely to be recommended to a consumer. Alternatively, the weighting of a particular content may be reduced to encourage other goals, like adding diversity to a list of recommended content or to discourage certain content.

The RC determination module 130 may be configured to determine a recommendation cluster (RC) for the first consumer ID. The RC determination module 130 may access a recommendation cluster database that maintains historical data for other consumer IDs regarding content played and an associated EL, by content, for each other consumer ID. The RC determination module 130 may use the historical data from the recommendation cluster to identify other consumer IDs that played the content associated with the first content ID and that had the same or similar EL or enhanced EL for the first content ID. The determined RC may be as small as one other consumer or as large as millions of other consumers. When the number of other consumers that also played or are also currently playing any given content is in the millions, various embodiments may limit and/or filter the determined RC to a more manageable number.

With reference to FIG. 1, the determined RC includes a plurality of other consumer IDs 2, 3, 4. Only three other consumer IDs 2, 3, 4 are illustrated for ease of explanation. However, it should be understood that a fewer or greater number of other consumer IDs may be included in the RC, depending upon the circumstances.

As discussed below with regard to the target consumer content experience data and the content experience data removal module 170, the historical data from other consumer IDs and the target consumer may be purged after it expires (e.g., after a set period, such as a week).

The size of the determined RC may reflect the popularity of the first content ID since the more consumers that play any particular content, the higher the likelihood that more consumers will be included in the determined RC. In this way, content distributors or providers may use a measure of the size of determined RC as a measure of trends or micro-trends in content demand (i.e., trending data). The measure of trends or micro-trends may be used to boost advertising revenue, drive content production and availability, and otherwise assist in the analysis of what content consumers like/want.

The RC determination module 130 may determine the RC shortly after the target consumer starts experiencing (i.e., viewing or listening to) the content of the first content ID. Thus, minutes after the target consumer starts playing the first content, trending data may be generated, which may in-turn modify recommendations of other content and even the advertisements shown while the rest of the first content is played by the first consumer. In addition, the RC determination module 130 may either continuously or periodically update the determined RC.

The RC determination module 130 may apply filters when determining the RC. For example, the time of day and/or the day of the week at which the content was played by the target consumer may be used to filter out other consumers who watched the first content at a different time of day or day of the week. Alternatively, the RC determination module 130 may limit the RC to other consumer IDs that played the first content within a predetermined time-window relative to the consumption period. Conversely, the RC determination module 130 may exclude from the RC other consumer IDs that did not play the first content within a predetermined time-window relative to the consumption period. For example, the time-window may represent a day of the week, a period of time (e.g., 4 hours) on the same date as the consumption period, a date, or a period of time on the same day of the week as that of the consumption period.

Alternatively, the RC determination module 130 may use one or more other ELs determined for the first consumer ID related to corresponding other content IDs as part of the RC determination. Each of the one or more other ELs may be based on consumption periods for corresponding additional content IDs. Thus, using the one or more other ELs determined for the first consumer ID, the RC determination module 130 may determine an RC that includes only other consumer IDs with a threshold number of matching ELs (e.g., at least 5 matching ELs) for the corresponding additional content IDs.

The content set determination module 140 may be configured to determine a set of additional content IDs based on a popularity of the additional content IDs within the recommendation cluster. The set of additional content IDs may comprise only those content IDs played by the recommendation cluster more than a threshold number of times. In this way, the determined content recommendation set may not include additional content IDs played by the recommendation cluster less than a threshold number of times. For example, only content IDs played by at least five other consumers (i.e., five other consumer IDs) may be included in the set of additional content IDs. As a further example, the threshold number may represent half the recommendation cluster, such that only content IDs played by a majority of the recommendation cluster may be included in the set of additional content IDs.

With reference to FIG. 1, the determined content recommendation set CR1 may be derived from a plurality of content sets C2, C3, C4 played by the recommendation cluster. Each of the plurality of content sets C2, C3, C4 may include a list of content played by the respective other consumer ID. In addition, each of the plurality of content sets C2, C3, C4 may include EL designations for the individual content included in the content set. In this way, each of the content sets may include a hierarchy of content, with the highest ELs having a higher ranking within the content set. From the plurality of content sets C2, C3, C4 only the content included in more than one content set has been selected for the determined content recommendation set CR1. In addition, the content included in the determined content recommendation set CR1 may include a ranking based on popularity within the plurality of content sets C2, C3, C4 and/or a weighting factor added thereto.

In various embodiments, a content distributor or provider may add to or remove content from a determined content recommendation set or even change the degree (i.e., higher or lower) to which particular content is recommended. In this way, if the content distributor or provider wants to encourage a particular content that did not naturally find its way into the determined content recommendation set or is ranked low in the determined content recommendation set, that particular content may be added to or raised in priority in the determined content recommendation set. For example, if the content provider identifies a global trend in the popularity of a given content (e.g., viewership is inordinately high or the content is trending on social media), that content provider may wish to add the content to the determined content recommendation set. Alternatively, the particular content may be moved up in the hierarchy of the determined content recommendation set in order to make it more likely that the particular content gets played by the consumer. Similarly, that particular content may be lowered in the hierarchy or removed entirely from the determined content recommendation set.

The content recommendation determination module 150 may be configured to determine at least one content recommendation based on the set of additional content IDs determined by the content set determination module 140. The at least one content recommendation may order the recommended additional content IDs based on a popularity of the respective content IDs within the recommendation cluster. In addition, the content recommendation determination module 150 may apply a recommendation weighting to particular content in order to move that content up or down in the recommendation order.

Various embodiments may associate or limit the content recommendation for any particular content ID to the device used to play the content. In this way, the same content recommendation may not be received on the kitchen TV as the den TV. Alternatively, a different content recommendation may be received on a kid's mobile phone as compared to the main family room television. Associating or limiting the content recommendations in this way may more directly associate recommendations to the computing device used to play the content.

The content recommendation storage/distribution module 160 may be configured to store the determined at least one content recommendation in the one or more memory storage devices 105. Additionally or alternatively, the content recommendation storage/distribution module 160 may be configured to transmit the determined at least one content recommendation to a remote memory storage device and/or to a remote computing device. In this way, the determined at least one content recommendation may be transmitted to the target consumer, if determined by a computing device of a content provider or distributor, or transmitted to the content provider or distributor, if determined by a computing device on the consumer side.

In addition, or alternatively, the content recommendation storage/distribution module 160 may control the automatic recording of the content associated with the at least one content recommendation. In fact, in accordance with various embodiments, the content recommendation storage/distribution module 160 may initiate and or control the automatic recording of the content associated with the at least one content recommendation without input from a user of the consumer ID specifically instructing that the content associated with the at least one content recommendation be recorded. In various embodiments, the automatic recording of recommended content may initially only record one instance or episode of the content, in order to allow the consumer to decide whether they want to play the content or record more content like the automatically recorded content.

The content experience data removal module 170 may remove from the recommendation cluster database the content experience data that has expired. The expiration date or expiration period of content experience data may be predetermined. For example, content experience data that is more than a week old may be considered expired. In this way, the content experience data removal module 170 may maintain a rolling window of one week of content experience data. The expiration date or period may be shorter or longer than a week if desired. Setting an expiration date or period for content experience data may establish a rolling window of current (i.e., “fresh”) data reflecting the target consumer's current moods and/or likes with respect to content. In addition, by applying an expiration date or period to content experience data the target user may not be locked-in to having content they previously liked influence all their later content recommendations. In this way, the rolling window of content experience data may adapt to the target consumer's current taste.

FIG. 2 illustrates a system block diagram of an IP network 200 suitable for use with the various embodiments. With reference to FIGS. 1-2, the IP network 200 may include one or more programmer servers 222, one or more guide vendor servers 224, one or more content distributor networks 210, and consumer computing devices 50, 55, 60. The programmer servers 222, guide vendor servers 224, content distributor networks 210, and consumer computing devices 50, 55, 60 may be connected together via one or more wired and/or wireless connections, such as connections to wired and/or wireless networks (e.g., connections to the Internet), and via those connections may exchange data with one another. In various embodiments, a content distributor network 210 may include various interconnected computing devices, such as an origin server 212, manifest manipulator server 214, and alternate content server 216. Via their connections (wired and/or wireless) with one another, the origin server 212, the manifest manipulator server 214, and the alternate content server 216 may exchange data with one another. In various embodiments, the content distributor network 210 may be operated by a content distributor (e.g., Charter®, Comcast®, DirecTV®, Sling® TV etc.) and may provide television services via IP streaming (e.g., ABR streaming, such as Apple HLS, DASH, etc., or any other type IP streaming) to consumers, such as consumer 1, via one or more of his or her consumer computing devices 50, 55, 60. As an example, computing device 60 may be a streaming media player (e.g., a ROKU®) or DVR connected to computing device 50 which may be a television. Computing device 60 may be optional as computing device 50 may itself connect to the content distributor network 210. For example, computing device 50 may be a smart television. As another example, computing device 55 may be a laptop computer, which may be connected with a wired (e.g., Ethernet) or wireless (e.g., Wi-Fi or Bluetooth®) to the content distributor network 210.

In various embodiments, the programmer server 222 may be a server of a programmer (e.g., Turner Broadcasting®, ESPN®, Disney®, Viacom®, etc.) that provides content for viewing by consumers, such as consumer 1, via the content distributor network 210. For example, the programmer server 222 may provide programmer content (i.e., content) to the origin server 212. An encoder and packager at the programmer server 222 or origin server 212 may format the programmer content and the origin server 212 may store the programmer content (i.e., content) for IP streaming. While the origin server 212 is illustrated in FIG. 1 as part of the content distributor network 210, the origin server 212 may be a server of a separate content delivery network (CDN) service, such as Akamai®, Amazon®, Netflix®, Hulu®, Vudu®, HBOGo®, etc., to which the content distributor network 210 operator or programmer offloads content storage and delivery. The programmer server 222 may also be configured to determine alternate content for the content in a programming schedule and generate a programmer alternate content mapping table for the program schedule indicating the determined programmer alternate content. The programmer server 222 may send the program schedule and the programmer alternate content mapping table to the guide vendor server 224.

The guide vendor server 224 may be configured to receive content schedules and programmer alternate content mapping tables from various programmers and generate a program guide, indicating programmer alternate content availability, or content recommendations. The guide vendor server 224 may be a server operated by a guide vendor (e.g., Gracenote®, Rovi®, etc.). The guide vendor server 224 may send the program guide indicating programmer alternate content availability or the content recommendations to the content distributor network 210, such as to the manifest manipulator server 214. In various embodiments, the content distributor network 210, such as the manifest manipulator server 214, may provide the program guide indicating programmer alternate content availability or the content recommendations to the consumer computing devices 50, 55, 60. Alternatively, the program guide indicating programmer alternate content availability or the content recommendations may be provided from the guide vendor server 224 to the consumer computing devices 50, 55, 60.

The manifest manipulator server 214 may be configured to generate manifest files, such as a .mpd type files for DASH, .m3u8 type files for Apple HLS, etc., that describe the programmer content provided by the programmer server 222 and stored at the origin server 212. The manifest files may be stored at the origin server 212 and may defined the segments of content provided by a programmer server 222 as well as segments for advertisements to be displayed according to an ad plan for a given content or channel Manifest files may be pre-generated by the manifest manipulator server 214 based on the program guide from the guide vendor server 224. In various embodiments, the manifest manipulator server 214 may be configured to modify the pre-generated manifest files to generate manifest files for programmer alternate content or the content recommendations. The manifest manipulator server 214 may provide manifest files to requesting ones of the consumer computing devices 50, 55, 60. The consumer computing devices 50, 55, 60 may use the manifest files or the content recommendations to retrieve and play content, including programmer alternate content or the content recommendations, to the consumer 1. For example, based on a content recommendation, the computing device 50, 55, 60 may stream segments of an on-demand video from the origin server 212.

In various embodiments, the consumer computing devices 50, 55, 60 may be configured to indicate consumer selections of programmer alternate content or a content recommendation to the content distributor network 210, such as to the alternate content server 216. The alternate content server 216 may store binding data relating a consumer identifier (ID) associated with an account of the consumer 1, such as the consumer's computing device identifier (e.g., MAC ID, etc.), subscribed identifier, etc., consumer feedback regarding content (e.g., a rating or like/dislike indication for a program by the consumer), and the consumer selection of the programmer alternate content. In this manner, a database of consumer's 1 feedback and the consumer's 1 preferred programmer alternate content may be established at the alternate content server 216. Such binding data may be referenced to select programmer alternate content with which to replace unappealing (or disliked) content for the consumer 1.

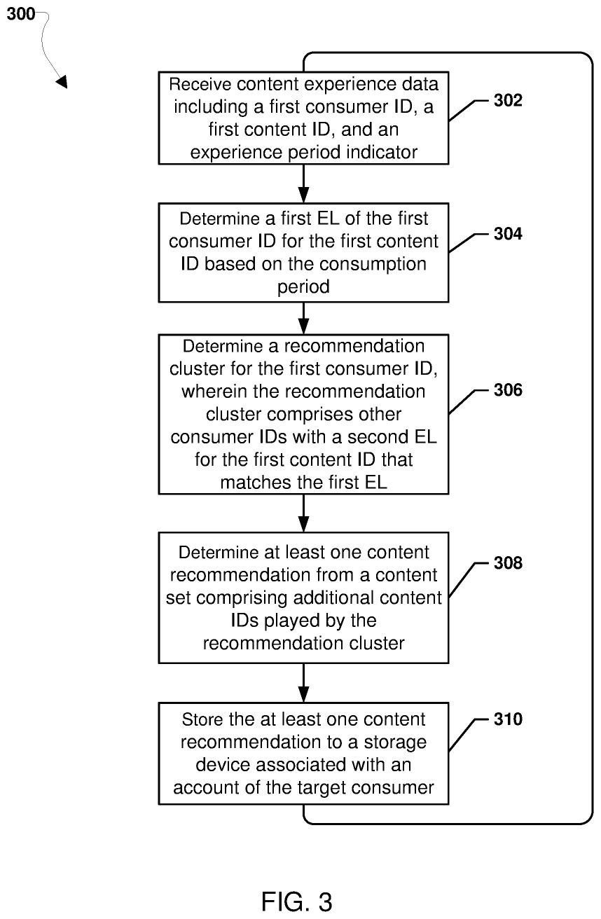

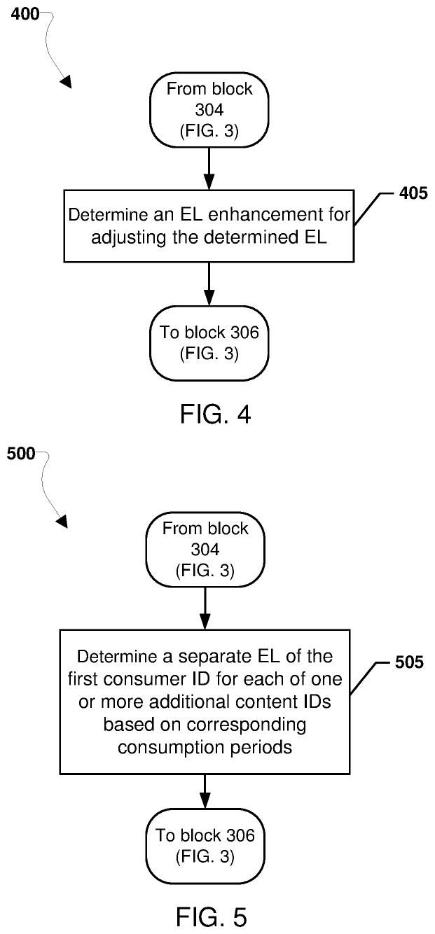

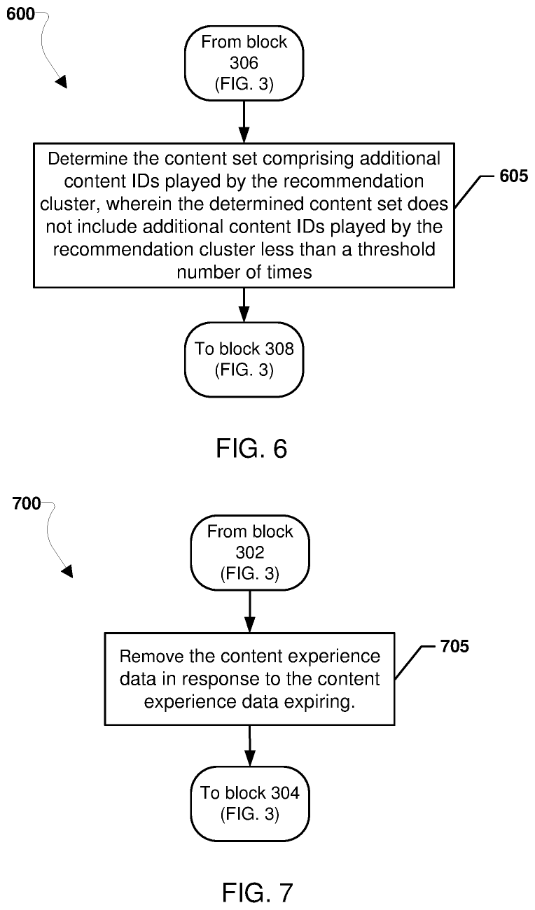

FIG. 3 illustrates an embodiment method 300 for making content recommendations to a consumer. With reference to FIGS. 1-3, the operations of method 300 may be performed by a processor (e.g., 107) of a computing device 100 (e.g., 50, 55, 60, 100) or server (e.g., programmer server 222, guide vendor server 224, alternate content server 216, manifest manipulator server 214, origin server 212).

In block 302, the processor may receive content experience data including a first consumer ID, a first content ID, and an experience period indicator. The content experience data may be received from a consumer computing device that has played the content associated with the first content ID or an intermediary computing device. The content experience data may be received at a content experience data receiving module (e.g., 110). The content experience data may identify the first consumer ID and may include a first content ID and an experience period indicator. In various embodiments, the content experience data may include a computing device identifier, feedback from the target consumer, and/or other data.

In block 304 the processor may determine a first EL of the first consumer ID for the first content ID based on the consumption period. The first EL of the first consumer ID may be determined by the EL determination module (e.g., 120). The EL may directly reflect how long the consumption period is, relative to a complete run-time of the content. Various embodiments may associate or limit the determined EL for any particular content ID to the time of day or day of the week the content was played or the device used to play the content.

In block 306, the processor may determine a recommendation cluster for the first consumer ID. The recommendation cluster may comprise other consumer IDs with a respective second EL for the first content ID that matches the first EL. The recommendation cluster may be determined by the RC determination module (e.g., 130). The processor, or the RC determination module, may access a recommendation cluster database that maintains historical data for other consumer IDs regarding content played and an associated respective EL, by content, for each other consumer ID. The processor 107 and/or the RC determination module 130 may use the historical data from the recommendation cluster to identify other consumer IDs that played the content associated with the first content ID and that had the same or similar EL or enhanced EL for the first content ID. In addition, the processor and/or the RC determination module may apply filters when determining the RC. Thus, the first consumer ID having a first EL is matched to other consumer IDs having the same or similar EL for the content.

In block 308, the processor 107 may determine at least one content recommendation from a content set comprising additional content IDs played by the recommendation cluster. The content recommendation may be determined by the content recommendation determination module (e.g., 150). The processor 107, or the content recommendation determination module 150, may be configured to determine at least one content recommendation based on the set of additional content IDs. In various embodiments, the processor 107 or the content recommendation determination module 150 may associate or limit the content recommendation for any particular content ID to the device 100 used to play the content.

In block 310, the processor 107 may store the at least one content recommendation in a storage device 105 associated with the computing device 100 and/or an account of the target consumer. The at least one content recommendation may be stored by the content recommendation storage/distribution module (e.g., 160). The processor 107, or the content recommendation storage/distribution module 160, may be configured to store the determined at least one content recommendation in the one or more memory storage devices (e.g., 105). In various embodiments, after or while storing the at least one content recommendation in the storage device, the processor 107, or the content recommendation storage/distribution module 160, may continue or once again receive content experience data including another consumer ID, first content ID, and experience period indicators in block 302. In such embodiments, recommendations of viewing content may be made without the need for any demographic information of the consumer. Rather, the recommendation may be made based on content consumption and engagement levels. Thus, anonymity of the consumers may be preserved.

FIG. 4 illustrates an embodiment method 400 of example operations that may be performed as part of the method 300 (FIG. 3) for making content recommendations to a consumer. With reference to FIGS. 1-4, the operations of method 400 may be performed by a processor (e.g., 107) of a computing device (e.g., 50, 55, 60, 100) or server (e.g., programmer server 222, guide vendor server 224, alternate content server 216, manifest manipulator server 214, origin server 212).

In some implementations following the operations of block 304 (FIG. 3), the processor may determine an EL enhancement in block 405 for adjusting the determined EL. The determined EL for any particular content ID may be adjusted by factoring-in feedback from the target consumer and/or other consumers.

Following the operations of block 405, the processor may perform the operations of block 306 (FIG. 3).

FIG. 5 illustrates an embodiment method 500 of example operations that may be performed as part of the method 300 (FIG. 3) for making content recommendations to a consumer. With reference to FIGS. 1-5, the operations of method 500 may be performed by a processor (e.g., 107) of a computing device (e.g., 50, 55, 60, 100) or server (e.g., programmer server 222, guide vendor server 224, alternate content server 216, manifest manipulator server 214, origin server 212).

In some implementations following the operations of block 304 (FIG. 3), the processor may determine a separate EL of the first consumer ID for each of one or more additional content IDs based on corresponding consumption periods in block 505.

Following the operations of block 505, the processor may perform the operations of block 306 (FIG. 3).

FIG. 6 illustrates an embodiment method 600 of example operations that may be performed as part of the method 300 (FIG. 3) for making content recommendations to a consumer. With reference to FIGS. 1-6, the operations of method 600 may be performed by a processor (e.g., 107) of a computing device (e.g., 50, 55, 60, 100) or server (e.g., programmer server 222, guide vendor server 224, alternate content server 216, manifest manipulator server 214, origin server 212).

In some implementations following the operations of block 306 (FIG. 3), the processor may determine the content recommendation set comprising additional content IDs played by the recommendation cluster, wherein the determined content recommendation set does not include additional content IDs played by the recommendation cluster less than a threshold number of times in block 605.

Following the operations of block 605, the processor may perform the operations of block 308 (FIG. 3).

FIG. 7 illustrates an embodiment method 700 of example operations that may be performed as part of the method 700 (FIG. 3) for making content recommendations to a consumer. With reference to FIGS. 1-7, the operations of method 700 may be performed by a processor (e.g., 107) of a computing device (e.g., 50, 55, 60, 100) or server (e.g., programmer server 222, guide vendor server 224, alternate content server 216, manifest manipulator server 214, origin server 212).

In some implementations following the operations of block 302 (FIG. 3), the processor may remove the content experience data, in block 405, in response to the content experience data expiring.

Following the operations of block 705, the processor may perform the operations of block 304 (FIG. 3).

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 300, 400, 500, 600, 700 may be substituted for or combined with one or more operations of the methods 300, 400, 500, 600, 700 and vice versa.

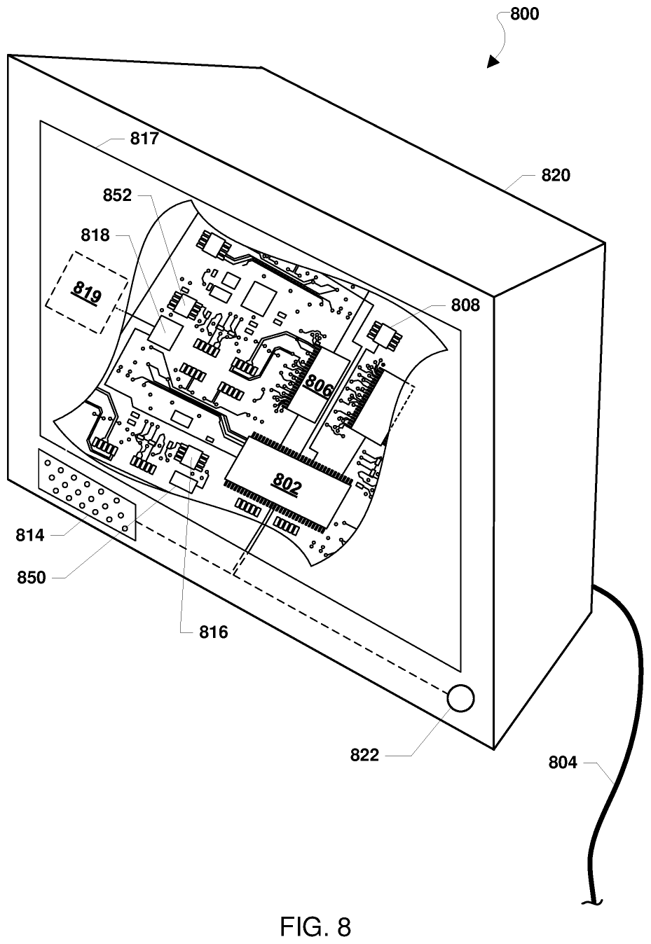

The various embodiments (including, but not limited to, embodiments discussed above with reference to FIGS. 1-7), may be implemented in any of a variety of computing devices (e.g., a smart television), an example of which is illustrated in FIG. 8. The smart television 800 may include a processor 802 and an internal memory 806. The processor 802 may be one or more multi-core integrated circuits designated for general or specific processing tasks. The internal memory 806 may be volatile or non-volatile memory and may also be secure and/or encrypted memory, or unsecure and/or unencrypted memory, or any combination thereof. In another embodiment (not shown), the smart television 800 may also be coupled to an external memory, such as an external hard drive. The smart television 800 may have one or more satellite, cable, or terrestrial tuners 808 coupled to the processor 802. The one or more tuners 808 may be used with the above-mentioned circuitry to receive and tune signals (e.g., television signals) received from a transmitter system (not shown) over a physical connection 804 (e.g., a connection to a cable network, a connection to an antenna, etc.). The tuner 808 and a connected antenna (internal to the television 800 or connected via physical connection 804 may be configured to receive IP streamed content.

The smart television 800 may have one or more radio signal transceivers 816 (e.g., Peanut®, Bluetooth®, Zigbee®, Wi-Fi, RF, cellular, etc.) and antennae 850, for sending and receiving, coupled to each other and/or to the processor 802. The transceivers 816 and antennae 850 may be used with the above-mentioned circuitry to implement various wireless transmission protocol stacks and interfaces. The smart television 800 may include one or more cellular network wireless modem chips 852, that enables communication via one or more cellular networks and that are coupled to the processor 802. The one or more cellular network wireless modem chips 852 may enable the smart television 800 to receive broadcast services from one or more cellular networks (e.g., CDMA, TDMA, GSM, PCS, 3G, 4G, LTE, or any other type of cellular network).

The smart television 800 may include a peripheral device connection interface 818 coupled to the processor 802. The peripheral device connection interface 818 may be singularly configured to accept one type of connection or may be configured to accept various types of physical and communication interfaces/connections, common or proprietary, such as USB, FireWire, Thunderbolt, or PCIe. The peripheral device connection interface 818 may also be coupled to a similarly configured peripheral device connection port (not shown), such as a connection port included on a conditional access module 819 in communication with the television 800.

The smart television 800 may also include speakers 814 for providing audio outputs. The smart television 800 may also include a housing 820, constructed of a plastic, metal, or a combination of materials, for containing all or some of the components discussed herein. The smart television 800 may be connected to a power source (not shown), such as a wall outlet. The smart television 800 may also include a physical button 822 for receiving consumer inputs. The smart television 800 may also include a display screen 817 coupled to the processor 802 and used for displaying visual images, such as television content, etc.

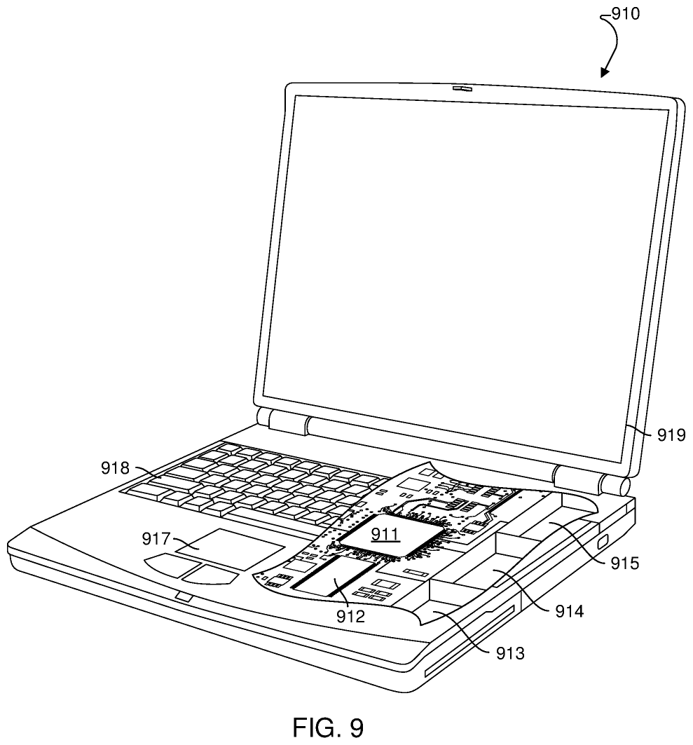

The various embodiments (including, but not limited to, embodiments discussed above with reference to FIGS. 1-7) described above may also be implemented within a variety of computing devices, such as a laptop computer 910 as illustrated in FIG. 9. Many laptop computers include a touch pad touch surface 917 that serves as the computer's pointing device, and thus may receive drag, scroll, and flick gestures similar to those implemented on mobile computing devices equipped with a touch screen display and described above. A laptop computer 910 will typically include a processor 911 coupled to volatile memory 912 and a large capacity nonvolatile memory, such as a disk drive 913 of Flash memory. The laptop computer 910 may also include a floppy disc drive 914 and a compact disc (CD) drive 915 coupled to the processor 911. The laptop computer 910 may also include a number of connector ports coupled to the processor 911 for establishing data connections or receiving external memory devices, such as a USB or FireWire® connector sockets, or other network connection circuits (e.g., interfaces) for coupling the processor 911 to a network. In a notebook configuration, the computer housing may include the touchpad 917, the keyboard 918, and the display 919 all coupled to the processor 911. Other configurations of the computing device may include a computer mouse or trackball coupled to the processor (e.g., via a USB input) as are well known, which may also be used in conjunction with the various embodiments.

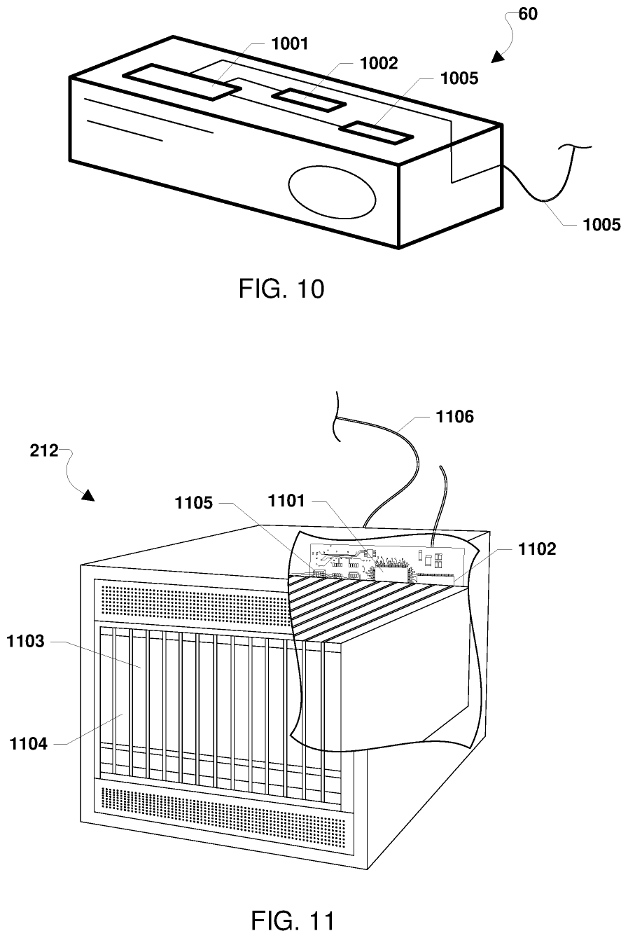

The various embodiments (including, but not limited to, embodiments discussed above with reference to FIGS. 1-7) may also be implemented on any of a variety of computing devices, such as the computing device 60, which may be a streaming media player or DVR, as illustrated in FIG. 10. Such a computing device 60 typically includes a processor 1001 coupled to volatile memory 1002. The computing device 60 may also include one or more connection or port 1006 coupled to the processor 1001 and configured to output streaming content to a display. The computing device 60 may also include one or more network transceivers 1005, such as a network access port, coupled to the processor 1001 for establishing wired or wireless network interface connections with a communication network, such as a local area network coupled to other computing devices and routers/switches, the Internet, the public switched telephone network, and/or a cellular network (e.g., CDMA, TDMA, GSM, PCS, 3G, 4G, LTE, or any other type of cellular network). The computing device 60 may receive media content via a network transceiver 1005 and output the media content to a display via the connection or port 1006.

Various embodiments (including, but not limited to, embodiments discussed above with reference to FIGS. 1-7) may be implemented on any of a variety of commercially available server devices, such as the server 212 illustrated in FIG. 11. The servers 214, 216, 222, and 224 illustrated in FIG. 2 may include the same or similar elements as the server 212 The server 212 may include a processor 1101 coupled to volatile memory 1102 and a large capacity nonvolatile memory, such as a disk drive 1103. The server 212 may also include a floppy disc drive, compact disc (CD) or DVD disc drive 1104 coupled to the processor 1101. The server 212 may also include network access ports 1106 coupled to the processor 1101 for establishing data connections with a network connection circuit 1105 and a communication network (e.g., IP network) coupled to other communication system network elements.

The processors 107, 802, 911, 1001, 1101 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 107, 802, 911, 1001, 1101. The processors 107, 802, 911, 1001, 1101 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 107, 802, 911, 1001, 1101 including internal memory or removable memory plugged into the device and memory within the processors 107, 802, 911, 1001, 1101 themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a module may be, but is not limited to, a process running on a processor, a processor, an object, an executable, a thread of execution, a program, or a computer. By way of illustration, both an application running on a computing device and the computing device may be referred to as a module. One or more modules may reside within a process or thread of execution and a module may be localized on one processor or core or distributed between two or more processors or cores. In addition, these modules may execute from various non-transitory processor-readable storage media having various instructions or data structures stored thereon. Modules may communicate by way of local or remote processes, function or procedure calls, electronic signals, data packets, memory read/writes, and other known network, computer, processor, or process related communication methodologies.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable storage media. Additionally, the operations of a method or algorithm may reside as one or any combination or set of codes and/or instructions on a non-transitory server-readable, processor-readable medium and/or computer-readable storage medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for making content recommendations to a target consumer, comprising:
receiving, at a processor of a computing device, content experience data associated with a first consumer ID, wherein the content experience data identifies the first consumer ID and includes a first content ID and an experience period indicator, wherein the first content ID is associated with a first content consumed by the target consumer and the experience period indicator is a measure of a consumption period when the first content was played by the first consumer ID;
determining, by the processor, a first engagement level (EL) of the first consumer ID for the first content ID based on the consumption period;
determining, by the processor accessing a recommendation cluster database, a recommendation cluster for the first consumer ID, wherein the recommendation cluster comprises other consumer IDs with a second EL for the first content ID that matches the first EL;
determining, by the processor, at least one content recommendation from a content set comprising additional content IDs played by the recommendation cluster; and
storing, by the processor, the at least one content recommendation to a storage device associated with an account of the target consumer.

2. The method of claim 1, wherein the content experience data also includes feedback from the first consumer ID related to the first content ID.

3. The method of claim 1, wherein the consumption period includes at least one of an elapsed time, a time of day, a day of the week, or a date during which the content was played by the first consumer ID.

4. The method of claim 1, wherein the first EL reflects how long the consumption period is relative to a complete run-time of the content.

5. The method of claim 1, wherein the first EL is associated with a time of day the first content was played by the first consumer, wherein the recommendation cluster comprises other consumer IDs with the ELs associated with the time of day the first content was played by the first consumer.

6. The method of claim 1, wherein the first EL is determined, at least in part, using a previous playing of the first content by the first consumer.

7. The method of claim 1, further comprising:
determining, by the processor, an EL enhancement for adjusting the determined EL, wherein the EL enhancement uses a weighting factor applied to the first EL to adjust the first EL used in matching the second EL for determining the recommendation cluster.

8. The method of claim 1, further comprising:
determining, by the processor, a separate EL of the first consumer ID for each of one or more additional content IDs based on corresponding consumption periods, wherein the recommendation cluster includes only other consumer IDs with a threshold number of matching EL's for the corresponding one or more additional content IDs.

9. The method of claim 1, wherein the recommendation cluster excludes other consumer IDs that did not play the first content within a predetermined time-window relative to the consumption period.

10. The method of claim 9, wherein the predetermined time-window is selected from a group comprising:
a same day of the week as that of the consumption period;
a period of time on the same date as the consumption period;
a date; or
a period of time on the same day of the week as that of the consumption period.

11. The method of claim 1, wherein the at least one content recommendation is selected from a list of additional content IDs based on a popularity of the additional content IDs within the recommendation cluster.

12. The method of claim 1, wherein determining the at least one content recommendation further comprises adding content not included in the content recommendation set.

13. The method of claim 1, wherein determining the at least one content recommendation further comprises changing an order in which content is recommended.

14. The method of claim 1, further comprising:
determining, by the processor, the content recommendation set comprising additional content IDs played by the recommendation cluster, wherein the determined content recommendation set does not include additional content IDs played by the recommendation cluster less than a threshold number of times.

15. The method of claim 1, further comprising:
automatically recording, by the processor to a media storage device, the content associated with the at least one content recommendation without input from a user of the first consumer ID specifically instructing that the content associated with the at least one content recommendation be recorded.

16. The method of claim 1, further comprising:
removing, by the processor from the recommendation cluster database, the content experience data in response to the content experience data expiring.

17. A computing device, comprising:
a memory; and
a processor coupled to the memory, wherein the processor is configured with processor-executable instructions to perform operations comprising:
receiving content experience data associated with a first consumer ID, wherein the content experience data identifies the first consumer ID and includes a first content ID and an experience period indicator, wherein the first content ID is associated with a first content consumed by a target consumer and the experience period indicator is a measure of a consumption period when the first content was played by the first consumer ID;
determining a first engagement level (EL) of the first consumer ID for the first content ID based on the consumption period;
determining, by accessing a recommendation cluster database, a recommendation cluster for the first consumer ID, wherein the recommendation cluster comprises other consumer IDs with a second EL for the first content ID that matches the first EL;
determining at least one content recommendation from a content set comprising additional content IDs played by the recommendation cluster; and
storing, in the memory, the at least one content recommendation to an account of the target consumer.

18. The computing device of claim 17, wherein the processor is configured with processor-executable instructions to perform operations such that the content experience data also includes feedback from the first consumer ID related to the first content ID.

19. The computing device of claim 17, wherein the processor is configured with processor-executable instructions to perform operations such that the consumption period includes at least one of an elapsed time, a time of day, a day of the week, or a date during which the content was played by the first consumer ID.

20. The computing device of claim 17, wherein the processor is configured with processor-executable instructions to perform operations such that the first EL reflects how long the consumption period is relative to a complete run-time of the content.

21. The computing device of claim 17, wherein the processor is configured with processor-executable instructions to perform operations such that the first EL is associated with a time of day the first content was played by the first consumer, wherein the recommendation cluster comprises other consumer IDs with the ELs associated with the time of day the first content was played by the first consumer.

22. The computing device of claim 17, wherein the processor is configured with processor-executable instructions to perform operations such that the first EL is determined, at least in part, using a previous playing of the first content by the first consumer.

23. The computing device of claim 17, wherein the processor is configured with processor-executable instructions to perform operations further comprising:
determining an EL enhancement for adjusting the determined EL, wherein the EL enhancement uses a weighting factor applied to the first EL to adjust the first EL used in matching the second EL for determining the recommendation cluster.

24. The computing device of claim 17, wherein the processor is configured with processor-executable instructions to perform operations further comprising:
determining a separate EL of the first consumer ID for each of one or more additional content IDs based on corresponding consumption periods, wherein the recommendation cluster includes only other consumer IDs with a threshold number of matching EL's for the corresponding one or more additional content IDs.

25. The computing device of claim 17, wherein the processor is configured with processor-executable instructions to perform operations such that the recommendation cluster excludes other consumer IDs that did not play the first content within a predetermined time-window relative to the consumption period.

26. The computing device of claim 25, wherein the processor is configured with processor-executable instructions to perform operations such that the predetermined time-window is selected from a group comprising:
a same day of the week as that of the consumption period;
a period of time on the same date as the consumption period;
a date; or
a period of time on the same day of the week as that of the consumption period.

27. The computing device of claim 17, wherein the processor is configured with processor-executable instructions to perform operations such that the at least one content recommendation is selected from a list of additional content IDs based on a popularity of the additional content IDs within the recommendation cluster.

28. The computing device of claim 17, wherein the processor is configured with processor-executable instructions to perform operations such that determining the at least one content recommendation further comprises adding content not included in the content recommendation set.

29. The computing device of claim 17, wherein the processor is configured with processor-executable instructions to perform operations such that determining the at least one content recommendation further comprises changing an order in which content is recommended.

30. The computing device of claim 17, wherein the processor is configured with processor-executable instructions to perform operations further comprising:
determining the content recommendation set comprising additional content IDs played by the recommendation cluster, wherein the determined content recommendation set does not include additional content IDs played by the recommendation cluster less than a threshold number of times.

31. The computing device of claim 17, wherein the processor is configured with processor-executable instructions to perform operations further comprising:
automatically recording, to the memory, the content associated with the at least one content recommendation without input from a user of the first consumer ID specifically instructing that the content associated with the at least one content recommendation be recorded.

32. The computing device of claim 17, wherein the processor is configured with processor-executable instructions to perform operations further comprising:
removing, from the recommendation cluster database, the content experience data in response to the content experience data expiring.

33. A non-transitory processor-readable storage medium having stored thereon processor-executable instructions configured to cause a processor to perform operations comprising:
receiving content experience data associated with a first consumer ID, wherein the content experience data identifies the first consumer ID and includes a first content ID and an experience period indicator, wherein the first content ID is associated with a first content consumed by a target consumer and the experience period indicator is a measure of a consumption period when the first content was played by the first consumer ID;
determining a first engagement level (EL) of the first consumer ID for the first content ID based on the consumption period;
determining, by accessing a recommendation cluster database, a recommendation cluster for the first consumer ID, wherein the recommendation cluster comprises other consumer IDs with a second EL for the first content ID that matches the first EL;
determining at least one content recommendation from a content set comprising additional content IDs played by the recommendation cluster; and
storing the at least one content recommendation to an account of the target consumer.

34. The non-transitory processor-readable storage medium of claim 33, wherein the stored processor-executable instructions are configured to cause the processor to perform operations such that the content experience data also includes feedback from the first consumer ID related to the first content ID.

35. The non-transitory processor-readable storage medium of claim 33, wherein the stored processor-executable instructions are configured to cause the processor to perform operations such that the consumption period includes at least one of an elapsed time, a time of day, a day of the week, or a date during which the content was played by the first consumer ID.

36. The non-transitory processor-readable storage medium of claim 33, wherein the stored processor-executable instructions are configured to cause the processor to perform operations such that the first EL reflects how long the consumption period is relative to a complete run-time of the content.

37. The non-transitory processor-readable storage medium of claim 33, wherein the stored processor-executable instructions are configured to cause the processor to perform operations such that the first EL is associated with a time of day the first content was played by the first consumer, wherein the recommendation cluster comprises other consumer IDs with the ELs associated with the time of day the first content was played by the first consumer.

38. The non-transitory processor-readable storage medium of claim 33, wherein the stored processor-executable instructions are configured to cause the processor to perform operations such that the first EL is determined, at least in part, using a previous playing of the first content by the first consumer.

39. The non-transitory processor-readable storage medium of claim 33, wherein the stored processor-executable instructions are configured to cause the processor to perform operations further comprising:
determining an EL enhancement for adjusting the determined EL, wherein the EL enhancement uses a weighting factor applied to the first EL to adjust the first EL used in matching the second EL for determining the recommendation cluster.

40. The non-transitory processor-readable storage medium of claim 33, wherein the stored processor-executable instructions are configured to cause the processor to perform operations further comprising:
determining a separate EL of the first consumer ID for each of one or more additional content IDs based on corresponding consumption periods, wherein the recommendation cluster includes only other consumer IDs with a threshold number of matching EL's for the corresponding one or more additional content IDs.

41. The non-transitory processor-readable storage medium of claim 33, wherein the stored processor-executable instructions are configured to cause the processor to perform operations such that the recommendation cluster excludes other consumer IDs that did not play the first content within a predetermined time-window relative to the consumption period.

42. The non-transitory processor-readable storage medium of claim 41, wherein the stored processor-executable instructions are configured to cause the processor to perform operations such that the predetermined time-window is selected from a group comprising:
a same day of the week as that of the consumption period;
a period of time on the same date as the consumption period;
a date; or
a period of time on the same day of the week as that of the consumption period.

43. The non-transitory processor-readable storage medium of claim 33, wherein the stored processor-executable instructions are configured to cause the processor to perform operations such that the at least one content recommendation is selected from a list of additional content IDs based on a popularity of the additional content IDs within the recommendation cluster.

44. The non-transitory processor-readable storage medium of claim 33, wherein the stored processor-executable instructions are configured to cause the processor to perform operations such that determining the at least one content recommendation further comprises adding content not included in the content recommendation set.

45. The non-transitory processor-readable storage medium of claim 33, wherein the stored processor-executable instructions are configured to cause the processor to perform operations such that determining the at least one content recommendation further comprises changing an order in which content is recommended.

46. The non-transitory processor-readable storage medium of claim 33, wherein the stored processor-executable instructions are configured to cause the processor to perform operations further comprising:
determining the content recommendation set comprising additional content IDs played by the recommendation cluster, wherein the determined content recommendation set does not include additional content IDs played by the recommendation cluster less than a threshold number of times.

47. The non-transitory processor-readable storage medium of claim 33, wherein the stored processor-executable instructions are configured to cause the processor to perform operations further comprising:
automatically recording the content associated with the at least one content recommendation without input from a user of the first consumer ID specifically instructing that the content associated with the at least one content recommendation be recorded.

48. The non-transitory processor-readable storage medium of claim 33, wherein the stored processor-executable instructions are configured to cause the processor to perform operations further comprising:
removing, from the recommendation cluster database, the content experience data in response to the content experience data expiring.
